(19) United States
(12) Patent Application Publication
(10) Pub. No.: US 2002/0046111 A1
(43) Pub. Date: Apr. 18, 2002

(54) Commodity data management apparatus and method

(76) Inventors: Kazuo Sumita, Kanagawa-ken (JP); Miwako Doi, Kanagawa-ken (JP); Soichiro Matsushita, Tokyo (JP); Hideki Hirakawa, Kanagawa-ken (JP)

Correspondence Address: FINNEGAN, HENDERSON, FARABOW, GARRETT &, DUNNER LLP, 1300 I STREET, NW, WASHINGTON, DC, 20005, US

(21) Appl. No.: 09/915,415

(22) Filed: Jul. 27, 2001

(30) Foreign Application Priority Data
Jul. 28, 2000 (JP) 2000-229772

(51) Int. Cl. G06F 17/60

(52) U.S. Cl. 705/14

(57) ABSTRACT

In a commodity data management apparatus, a communication unit receives purchase commodity data of each customer in time series from a commodity data input and output apparatus. A data analysis unit determines a tendency of purchase commodity of each customer according to the purchase commodity data received. The communication unit sends commodity presentation data based on the tendency of purchase commodity to the commodity data input and output apparatus of the customer. The commodity presentation data is usable for the customer's next purchase. In the commodity data input and output apparatus, a communication unit receives the commodity presentation data, and a display unit displays the commodity presentation data to the customer.

### CROSS-REFERENCE TO RELATED APPLICATIONS

This application is based upon and claims the benefit of priority from the prior Japanese Patent Application PH2000-229772, filed on Jul. 28, 2000; the entire contents of which are incorporated herein by reference.

### FIELD OF THE INVENTION

The present invention relates to a commodity data management apparatus and a method for analyzing a customer's purchase history in a store, and for presenting commodity data to the customer according to the analysis result.

### BACKGROUND OF THE INVENTION

Recently, in proportion to increasing commodity availability, a customer's needs have increased and diversified. By correctly understanding the customer's needs, sales increase. In a large store such as a supermarket, by utilizing POS (point of sales management system), the customer's purchase history is analyzed and reflected in an arrival commodity plan. In a commodity data management system, when a price of the commodity is calculated at a register counter, data of purchase situation is also input. By introducing such a system, various analysis or statistics can be executed. For example, which commodity is largely purchased, how many of the commodity are purchased, which commodities are purchased at one time shopping, and any relation between the commodity sale and outside status such as weather, are understood. This analysis is effective for the arrival plan of commodity hereinafter.

However, in the commodity data management system of the prior art, in case of inputting purchase data at the register counter, the purchase data at a payment timing of the customer is only inputted. Accordingly, time series analysis cannot be executed. For example, in the store, a course through which the customer purchases a plurality of commodities is not understood.

Furthermore, in Japanese Patent Disclosure (Kokai) PH8-63668, by preparing a display unit on a shopping cart, the commodity data management system in which the customer's location is displayed on a map of the store is disclosed. In this system, means for detecting the commodities location, and means for detecting the customer's location are equipped. The customer can confirm a location of a desired commodity and a course to the location of the commodity in the store through the display.

Furthermore, in Japanese Patent Disclosure (Kokai) PH6-130922, the commodity data management system in which sale information of each counter is presented to the customer is disclosed. In this system, each counter includes a transmitter for remotely transmitting infrared rays, and a receiver on the shopping cart receives data from the transmitter at each counter.

In the above-mentioned commodity data management systems using the shopping cart, the shopping cart functions as a display apparatus. In short, it is not utilized for analyzing the customer's purchase tendency.

### BRIEF SUMMARY OF THE INVENTION

It is an object of the present invention to provide commodity data management apparatus and method for presenting commodity data usable for the customer by analyzing the customer's tendency of purchase commodity.

According to an aspect of the present invention, there is provided a commodity data management method comprising: inputting purchase commodity data of each customer in time series at the time the customer selects the commodity; and determining a tendency of purchase commodity of each customer according to the purchase commodity data of each customer inputted in time series.

Further in accordance with another aspect of the present invention, there is also provided a commodity data input and output apparatus, comprising: an input unit configured to input purchase commodity data of each customer in time series at the time the customer selects the commodity; and a communication unit configured to send the purchase commodity data of each customer to a commodity data management apparatus.

Further in accordance with another aspect of the present invention, there is also provided a method for inputting and outputting commodity data, comprising: inputting purchase commodity data of each customer in time series at the time the customer selects the commodity; and sending the purchase commodity data of each customer to a commodity data management apparatus.

Further in accordance with another aspect of the present invention, there is also provided a computer program product for use with a computer, comprising: a computer usable medium having computer readable program code embodied in said medium for causing said computer to input and output commodity data, said computer readable program code having: computer readable program code to input purchase commodity data of each customer in time series at the time the customer selects the commodity; and computer readable program code to send the purchase commodity data of each customer to a commodity data management apparatus.

Further in accordance with another aspect of the present invention, there is also provided a commodity data management apparatus, comprising: a communication unit configured to receive purchase commodity data of each customer in time series at the time the customer selects the commodity from a commodity data input and output apparatus; and a data analysis unit configured to determine a tendency of purchase commodity of each customer according to the purchase commodity data of each customer received.

Further in accordance with another aspect of the present invention, there is also provided a method for managing commodity data, comprising: receiving purchase commodity data of each customer in time series at the time the customer selects the commodity from a commodity data input and output apparatus; and determining a tendency of purchase commodity of each customer according to the purchase commodity data of each customer received.

Further in accordance with another aspect of the present invention, there is also provided a computer program product for use with a computer, comprising: a computer usable medium having computer readable program code embodied in said medium for causing said computer to manage commodity data, said computer readable program code having: computer readable program code to receive purchase commodity data of each customer in time series at the time the customer selects the commodity from a commodity data input and output apparatus; and computer readable program code to determine a tendency of purchase commodity of each customer according to the purchase commodity data of each customer received.

### BRIEF DESCRIPTION OF THE DRAWINGS

FIG. 1 is a block diagram of a commodity data management system according to various embodiments of the present invention.

FIG. 2 is a block diagram of the commodity data management system according to the first embodiment of the present invention.

FIG. 3 is a flow chart of a control unit of the shopping cart according to the first embodiment of the present invention.

FIG. 4 is a flow chart of a control unit of a data collection server according to the first embodiment of the present invention.

FIG. 5 is a schematic diagram of a counter table according to various embodiments of the present invention.

FIG. 6 is a flow chart of processing of a data accumulation unit according to the first embodiment of the present invention.

FIG. 7 is a schematic diagram of a purchase commodity table according to various embodiments of the present invention.

FIG. 8 is a schematic diagram of a commodity table according to various embodiments of the present invention.

FIG. 9 is a schematic of a data analysis result table according to various embodiments of the present invention.

FIG. 10 is a block diagram of the commodity data management system according to the second embodiment of the present invention.

FIG. 11 is a flow chart of processing of a data provision unit according to the second embodiment of the present invention.

FIG. 12 is a schematic diagram of an advertisement data table according to the second embodiment of the present invention.

FIG. 13 is a flow chart of processing of the data provision unit according to the third embodiment of the present invention.

FIG. 14 is a schematic diagram of a location data table according to the third embodiment of the present invention.

FIG. 15 is a schematic diagram of a terminal of shopping cart type according to various embodiments of the present invention.

FIG. 16 is a schematic diagram of the shopping cart of PDA type according to various embodiments of the present invention.

FIG. 17 is a schematic diagram of the shopping cart of wearable type according to various embodiments of the present invention.

FIG. 18 is a flow chart of processing of the control unit of the data collection server according to the fourth embodiment of the present invention.

FIG. 19 is a schematic diagram of a question table according to the fourth embodiment of the present invention.

FIG. 20 is a schematic diagram of an answer table according to the fourth embodiment of the present invention.

FIG. 21 is a flow chart processing of the control unit of the shopping cart according to the fourth embodiment of the present invention.

### DETAILED DESCRIPTION OF THE INVENTION

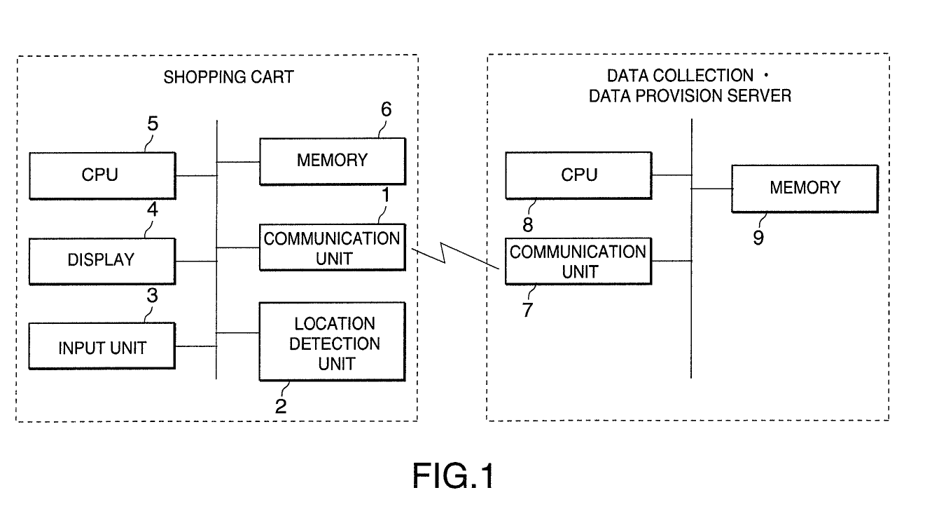

Hereinafter, various embodiments of the present invention will be explained by referring to the drawings. FIG. 1 is a block diagram of components of commodity data management system according to various embodiments of the present invention. While a plurality of shopping carts may be utilized by each customer, in FIG. 1, components of only one shopping cart are shown.

In the shopping cart side, a communication unit 1 remotely communicates to a server. A location detection unit 2 detects a location of the shopping cart. An input unit 3 inputs a code of purchase commodity of the customer (For example, a barcode input apparatus, a keyboard, a pen input apparatus, a speed input apparatus). A display unit 4 displays the amount of price of the commodities purchased by the customer and a present location of the customer (For example, a liquid crystal display). A CPU 5 controls the communication unit 1, the location detection unit 2, the input unit 3, and the display unit 4. A memory 6 stores programs to control the CPU 5 and various data.

In the data collection server side, a communication unit 7 for remotely communicating to the shopping cart, a CPU 8 for controlling the communication unit 7 and for controlling collection, analysis, provision of data obtained by the communication unit 7, and a memory 9 for storing program to control the CPU 8 and various data are included. In the present invention, components of the shopping cart and the server are defined as shown in FIG. 1. However, combinations of the components may be arbitrarily changed.

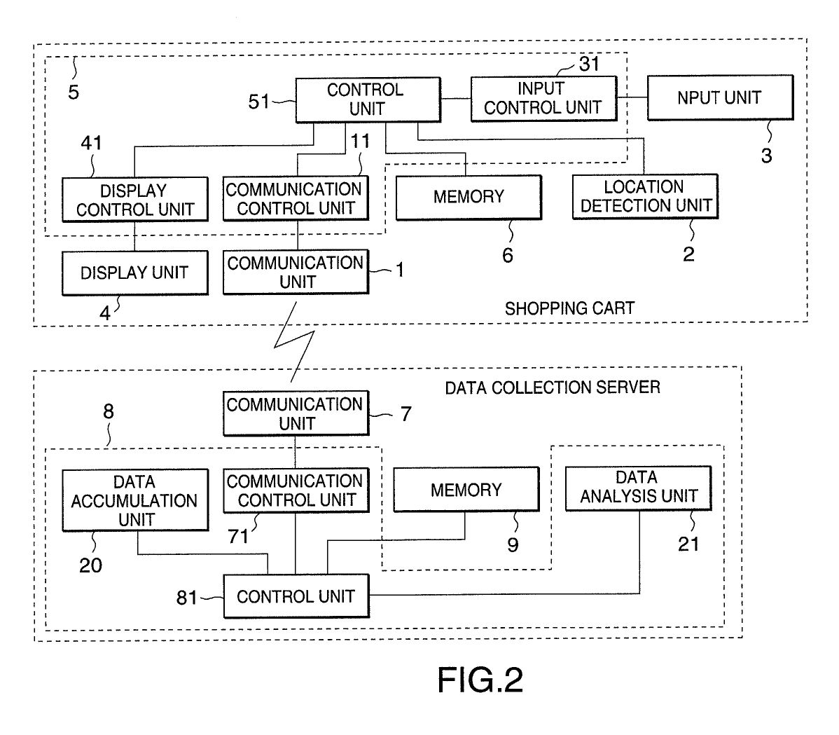

In the first embodiment, a function to collect data representing purchase tendency of the customer in time series (the order of purchasing commodities) is explained. FIG. 2 is a block diagram of the commodity data management system according to the first embodiment.

The shopping cart includes the display unit 4, a display control unit 41 for controlling the display unit 4, the communication unit 1, a communication control unit 11 for controlling the communication unit 1, the input unit 3, an input control unit 31 for controlling the input unit 3, and the location detection unit 2. In case of not presenting data to the customer, the display unit 4 is not necessary.

The data collection server includes the communication unit 7 for communicating to the shopping cart, a communication control unit 71 for controlling the communication unit 7, a data accumulation unit 20 for executing accumulation processing of purchase data of each customer received from the shopping cart, a data analyses unit 21 for analyzing the purchase data, the memory 9 for storing the accumulated data and the analysis result, and a control unit 81 for controlling each unit.

As for the location detection unit 2, in case of detecting a present location of the shopping cart, a plurality of methods using an electric wave or a supersonic wave is already utilized. The detection method of present location is not the subject of the present invention, and any known techniques may be utilized. For example, in Japanese patent Disclosure (Kokai) PH11-69404, the disclosure of which is incorporated by reference, the location detection service using PHS is disclosed. The equivalent technique is utilized for the location detection.

This technique is simply explained. An information provider provides a service provision system including a store database. Furthermore, a telephone company provides a local telephone number database and a location detection processing unit. The user who carries a personal cellular phone requests of the telephone company to provide information through the personal cellular phone. At the telephone company, the location detection processing unit detects a present location of the user, and a telephone number of a corresponding information provider is found from the telephone number database. The telephone company connects circuits of the personal cellular phone to the corresponding information provider using the telephone number. In this way, the user can receive data provision from the store database of the information provider.

Furthermore, the communication unit 1,7 for communicating data between the shopping cart and the data collection server is a known technique, and not the subject of the present invention. As for the communication unity, for example, PHS, IrDA as infrared rays, and Blue Tooth as a short distance wireless, are utilized.

Accordingly, in the following embodiments, the communication unit 1 and the location detection unit 2 are not explained. The other units are explained. First, summary of operation of data communication between the shopping cart and the data collection server is explained.

In the shopping cart, the location detection unit 2 detects its own location in the store. Then, the customer inputs the commodity data to be purchased through the input unit 3 (For example, a barcode input apparatus). In this case, the customer must input each commodity code. However, the commodity code inputted by the customer may be accumulated for each customer. The time taken for accumulating the commodity price at the register counter can be omitted, and the customer need not wait for clear accounts at the register counter. This is a large merit for the customer.

The purchase commodity data (For example, ID code of commodity), the location data, and ID code of the shopping cart are sent to the data collection server through the communication unit 1. By using an existing technique such as wireless tag, the barcode input apparatus for the customer to input the purchase commodity data is not necessary. For example, the commodity data can be inputted while placing the commodity in the shopping cart. A wireless tag is attached to each commodity, and the wireless tag transmits an ID code corresponding to the commodity. In the shopping cart, a receiving means receives the ID code from the wireless tag. When the commodity is stacked in the shopping cart, the wireless tag attached to the commodity is close to the receiving means. Accordingly, it can be detected which commodity is stacked in the shopping cart. Furthermore, in case of summing up the order of the purchase commodity only, sending of the location data may be omitted.

In the data collection server, an ID code of the shopping cart, an ID code of the purchased commodity, and the location data are received by the communication unit 7. Then, the data accumulation unit 20 arranges the ID code of the purchase commodity with the purchase time (receiving time) for each shopping cart and stores the purchase commodity data in time series in the memory 7. The data analysis unit 21 executes analysis processing of the purchase commodity time series data.

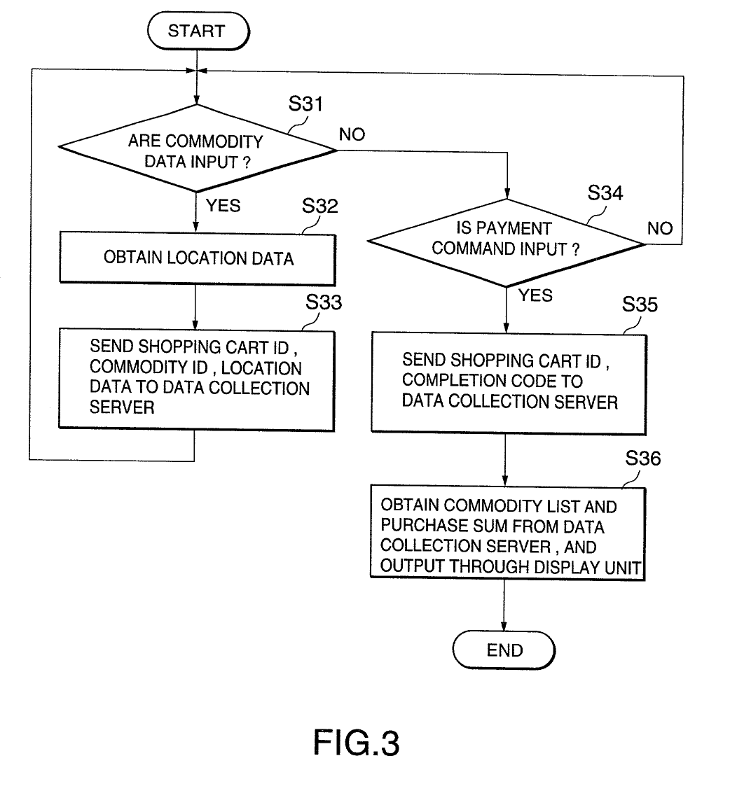

FIG. 3 is a flow chart of processing of the control unit 51 of the shopping cart 51. When the shopping cart is activated, the control unit waits for input data from the customer (S31). If the input data from the customer is the commodity data, the location detection unit 2 detects location data (S32). Then, the communication unit 1 sends an ID code of the shopping cart, an ID code of the commodity, and the location data to the data collection server (S33). This processing is executed whenever the commodity data is inputted. On the other hand, when a payment command is inputted (S34), an ID code of the shopping cart and a completion code are sent to the data accumulation unit 20 of the data collection server by the communication units 1,7 (S35). When a list of purchased commodities and the total price of the purchased commodities are received from the data collection server, the display unit 4 displays the list and the total amount (S36). However, the sum of the price is not the main subject of the present invention, and this processing is not explained in detail.

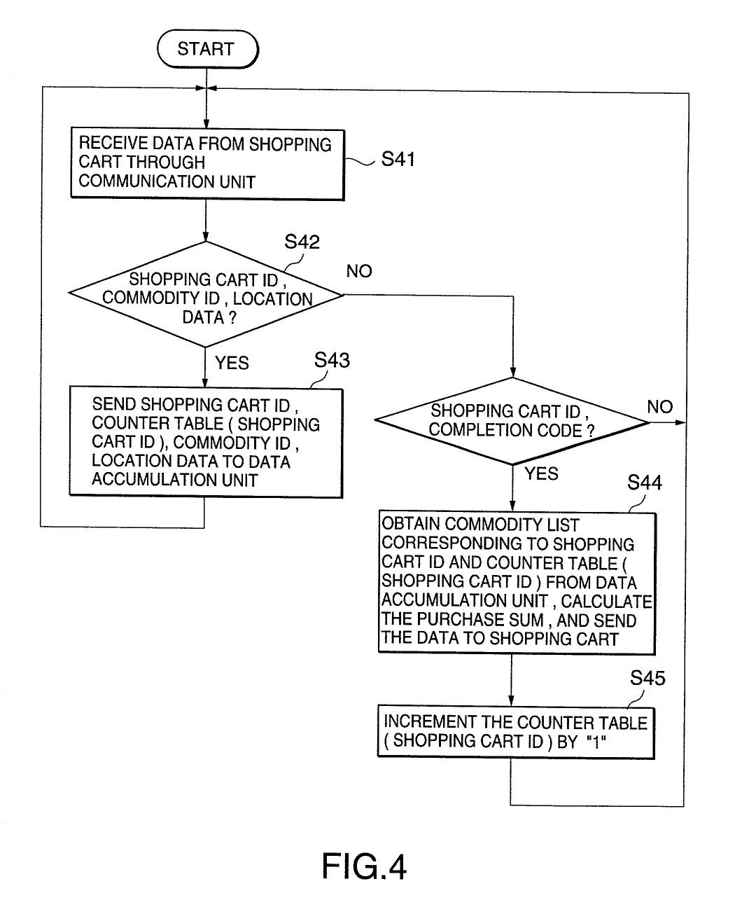

FIG. 4 is a flow chart of processing of the control unit 81 of the data collection server. In the data collection server, the communication unit receives the purchase commodity data of each customer sent from the shopping cart (S41). The purchase commodity data is previously input by the input unit 3 of the shopping cart. In case of receiving an ID code of the shopping cart, an ID code of the commodity (S42) and the location data, these data are sent to the data accumulation unit 20 (S43). On the other hand, when the completion code is received, an accumulated result of the purchase commodity received are obtained from the data accumulation unit 20 and sent to the corresponding shopping cart (S44). In this case, a counter table is used to identify the shopping cart for each customer. FIG. 5 is one example of the counter table. In the counter table, a counter value is initialized as “0” at the beginning. This initialization may be executed once a day in case of opening a store. In the data collection server, whenever the completion code is received for each shopping cart ID, the counter value corresponding to the shopping cart ID is incremented by “1” (S45). In short, whenever the customer of each shopping cart changes, the counter value is incremented by unit of “1”. Accordingly, each customer of the same shopping cart can be discriminated.

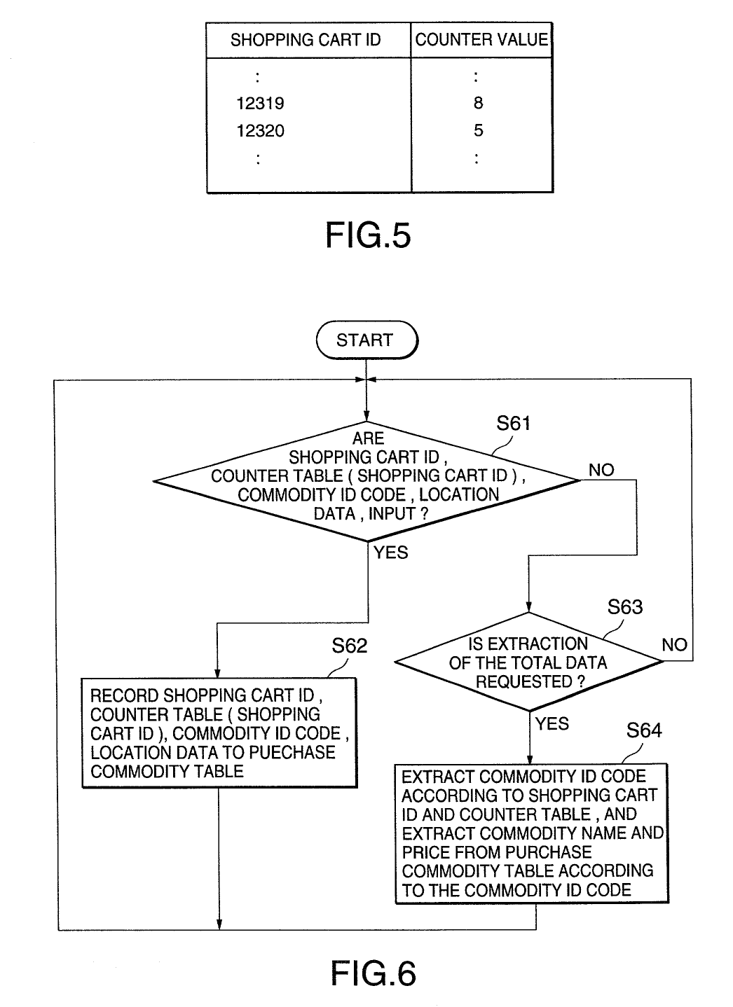

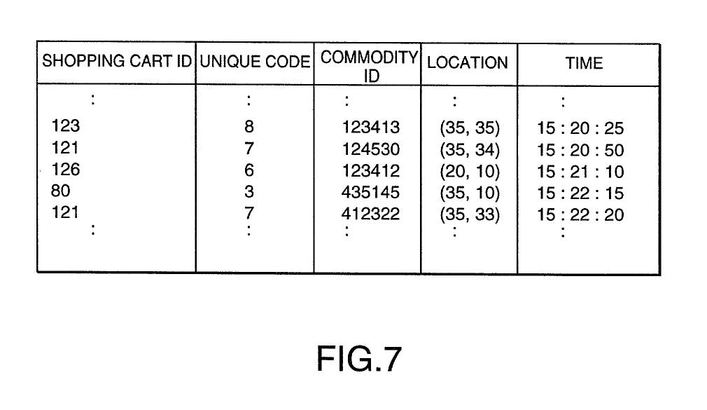

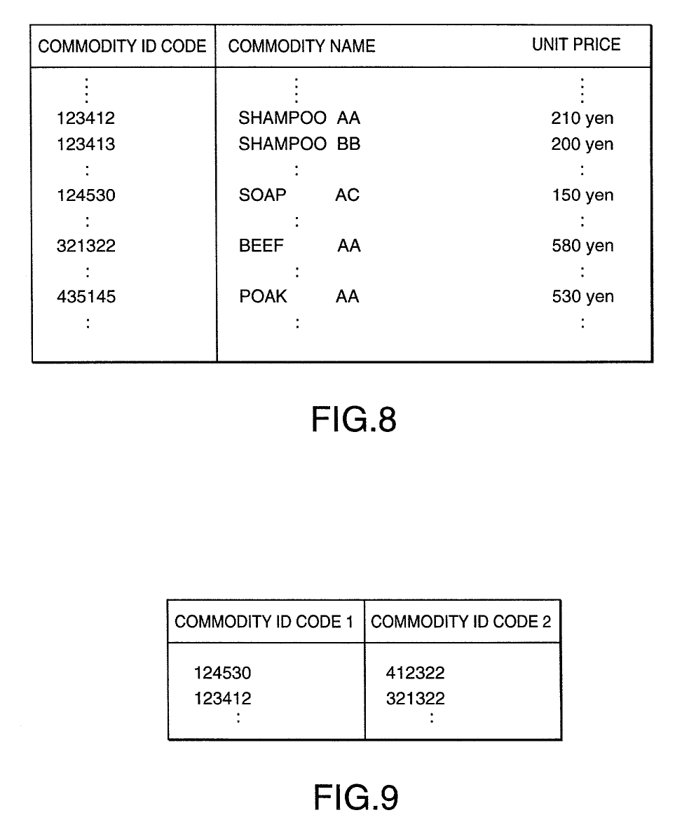

FIG. 6 is a flow chart of processing of the data accumulation unit 20. If the ID code of the purchase commodity, the ID code of the shopping cart, the counter value of shopping cart ID in the counter table, and the location data are received from the control unit 81 (S61), these data are recorded in a purchased commodity table (S62). FIG. 7 is a format of the purchased commodity table. In this purchased commodity table, “unique code” represents the counter value obtained from the counter table, and “time” represents receiving time of the commodity data. Furthermore, when an extraction request of the total amount is received from the control unit 81 according to the completion code from the customer (S63), the sum of purchased commodities for the customer is calculated by referring to the purchased commodity table and a commodity table (S64). FIG. 8 is one example of the commodity table. In this commodity table, the commodity ID code, the commodity name, and a unit price are previously recorded. These data in the commodity table are registered in case of exhibiting the commodity.

Next, processing of the data analysis unit is explained. In the data analysis unit, data mining processing is executed. A method of the data mining processing is disclosed in the following references, the disclosures of which are incorporated by reference.

(1) “Machine Learning and Date Mining”, Hiroshi Motoda, Takashi Washio, (Journal of Japanese Society for Artificial Intelligence, Vol. 12, No. 4, pp. 505-512)

(2) “Mining Algorithm for Association Rules”, Masaru Kitsuregawa, (Journal of Japanese Society for Artificial Intelligence, Vol. 12, No4, pp. 513-520)

(3) “Data Mining for Distribution Industory”, Masayuki Numao, Shuichi Shimizu, (Journal of Japanese Society for Artificial Intelligence, Vol. 12, No4, pp. 528-535)

In case that the data collection server collects the commodity ID code and the purchase time of the commodity, one example of processing of the data analysis unit 21 is explained. In the purchase commodity table shown in FIG. 7, a pair of the commodity ID codes purchased by the same customer within a predetermined time interval is extracted. Furthermore, a pair of the commodity ID codes purchased by the same customer at one time shopping is extracted. In this way, a pair of commodities continually purchased by the same customer is extracted and accumulated. Then, the pair of commodities of which occurrence frequency is large is extracted as an analysis result. In this case, as shown in FIG. 9, a pair of the commodity ID codes is stored in the memory 9. This analysis result for tendency of purchase commodity is utilized for planning of commodity exhibition.

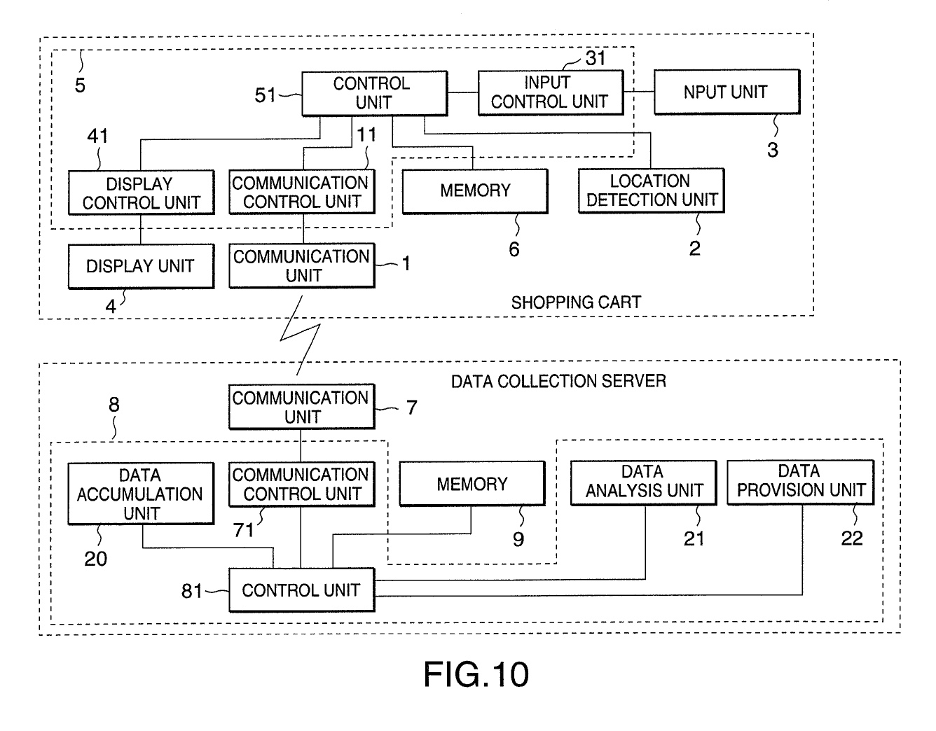

Next, in the second embodiment, the commodity data based on the customer's purchase tendency is presented to the customer. FIG. 10 is a block diagram of the commodity data management system according to the second embodiment. A difference from the first embodiment is a data provision unit 22 in the data collection server. The data provision unit 22 provides commodity data based on the commodity purchase data outputted by the data accumulation unit 20 and the data analysis result outputted by the data analysis unit 21. For example, if the data analysis result represents that a ratio of customers who purchases a commodity 1 is large after purchasing a commodity 2, an advertisement of the commodity 1 should be presented to a customer who purchased the commodity 2. In this case, a possibility that the customer will purchase the commodity 1 is high. Furthermore, location of a counter of the commodity 1 should be presented to the customer who purchased the commodity 2. An advertisement for the commodity 1 may be presented while the customer who purchased the commodity 2 is passing near a counter of the commodity 1.

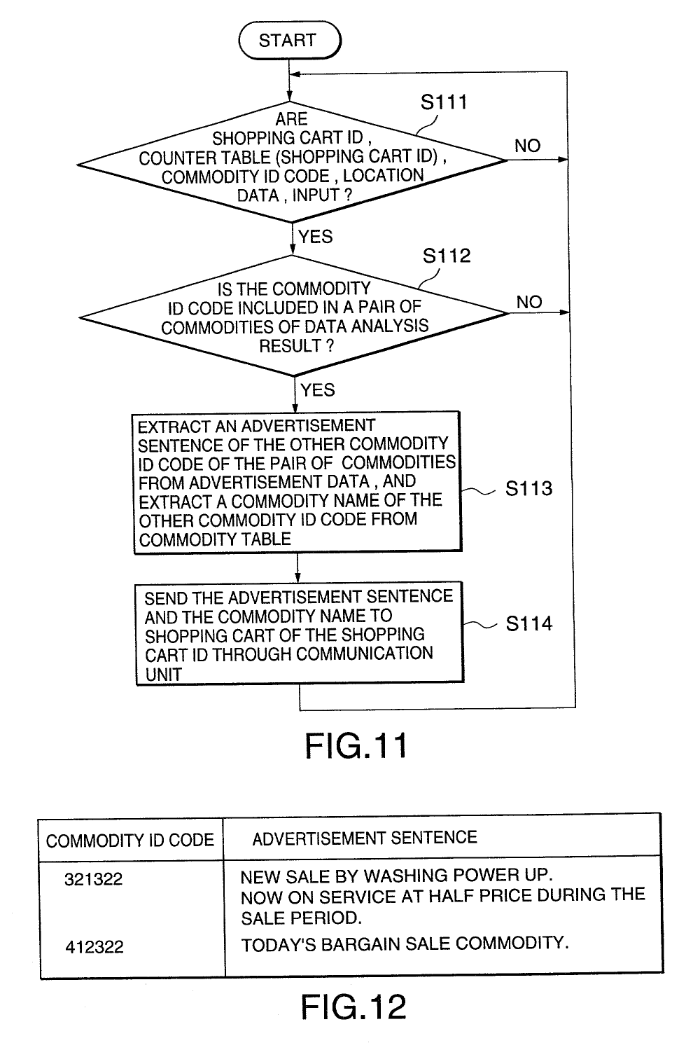

FIG. 11 is a flow chart of processing of the data provision unit 22 in case of presenting an advertisement of commodity related to the customer's purchased commodity. In response to input of the commodity data from the customer, the ID code of the shopping cart, the ID code of the purchased commodity, and the location data, are sent from the shopping cart to the data collection server. In the data collection server, the data accumulation unit 20 and the data analysis unit 21 are operated in the same way as in the first embodiment. On the other hand, the data provision unit executes processing shown in FIG. 11, independently from other units. First, it is decided whether the received commodity ID code is included in the data analysis result table (S112). If the commodity ID code matches one commodity ID code of a pair of commodities, the other commodity ID code of the pair of commodities is extracted. Then, an advertisement sentence of the other commodity ID code is extracted from advertisement data and sent to the shopping cart. Assume that a customer purchases a commodity of ID code “123412”. As shown in FIG. 9, the commodity ID code “123412” is included in the data analysis result table, and the other ID code “321322” of the pair of commodities including the ID code “123412” is extracted. Then, an advertisement, such as text, for commodity ID code “321322” is extracted from the advertisement data. FIG. 12 is one example of the advertisement data. In this case, the advertisement sentence “New sale by washing power up. Now on service at half price during the sale period.” and the commodity name is sent to the shopping cart. The advertisement data is previously stored in the memory 9 of the data collection server. As shown in FIG. 12, the commodity ID code and advertisement sentence are correspondingly stored in the memory 9 of the data collection server. The advertisement sentence may include an image related to the commodity.

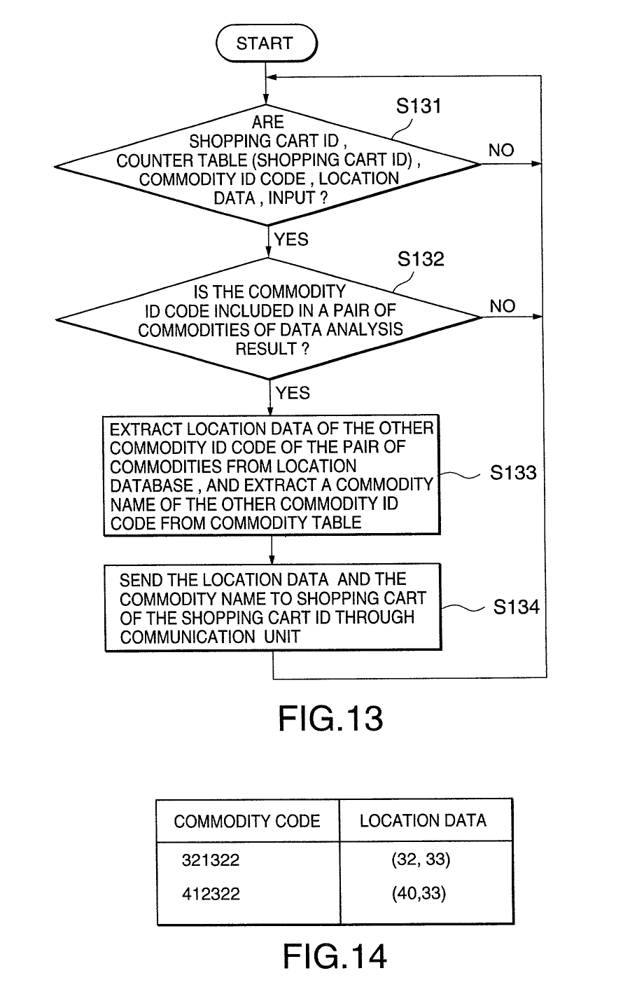

Next, according to a third embodiment, the location of counter of commodity related to the customer's purchased commodity is presented to the customer. FIG. 13 is a flow chart of processing of the data provision unit 2 of the data collection server according to the third embodiment. A difference from the second embodiment is that the location data of a commodity related to the customer's purchased commodity is presented instead of the advertisement sentence. First, in response to input of the commodity data from the customer, the ID code of the shopping cart, the ID code of the purchased commodity, and the location data are sent from the shopping cart to the data collection server. In the data collection server, the data accumulation unit 20 and the data analysis unit 21 are operated in the same way as in the first embodiment.

On the other hand, the data provision unit executes processing shown in FIG. 13, independently from other units. First, it is decided whether the received commodity ID code is include in the data analysis result table (S132). If the commodity ID code is matched with one commodity ID code of a pair of commodities, the other commodity ID code of the pair of commodities is extracted. Then, the location data of the other commodity ID code is extracted from a location database and sent to the shopping cart (S133). Assume that some customer purchases a commodity of ID code “123412”. As shown in FIG. 9, the commodity ID code “123412” is included in the data analysis result table, and the other ID code “321322” of the pair of commodities including the ID code “123412” is extracted. Then, the location data of commodity code “321322” is extracted from the location database. FIG. 14 is one example of the location database. In this case, the location data “(32,33)” and the commodity name is sent to the shopping cart. The location database is previously stored in the memory 9 of the data collection server. As shown in FIG. 14, the commodity ID code and the location data are correspondingly stored in the memory 9 of the data collection server. In the shopping cart, after receiving the commodity name and the location data, a point corresponding to the location data is drawn onto a store map stored in the shopping cart. A mapping method for drawing a location point onto the map is already executed in car navigation system. Accordingly, the explanation is omitted. As the specific feature of the third embodiment, the customer's tendency of purchase commodity is analyzed based on the purchase commodity data from the shopping cart, and the location of commodity apt to be purchased next is displayed on the store map according to the analysis result.

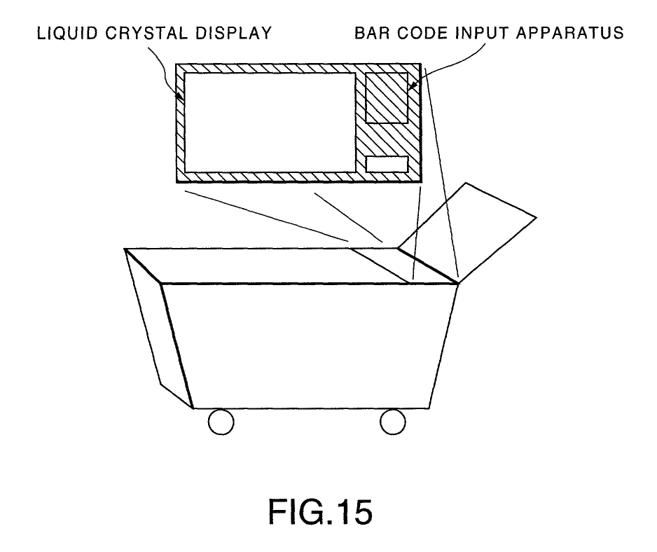

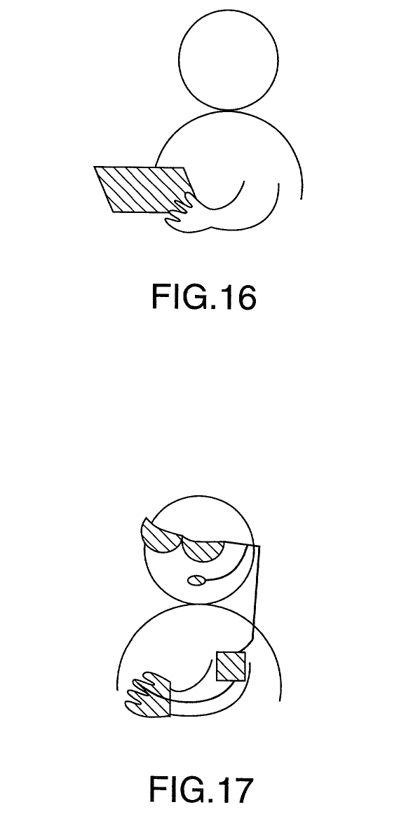

Next, a modification example of shape of the shopping cart is explained. In order to accomplish the present invention, the shopping cart may not have a shape for collecting the purchased commodities. As an example following a usual shape of the shopping cart, FIG. 15 shows a shopping cart for collecting the purchased commodities in a store. In this shopping cart, a display unit (liquid display) presents an advertisement sentence or a map, and an input unit (barcode input apparatus) inputs the commodity data. As for a basket to stack the commodity, a part of information processing function to execute display input, and communication, may be attachable shape. In the usual store, the total of price of purchase commodities is calculated at a register counter. In order to pay, the purchased commodities must be stacked in a shopping cart. However, in a system to input the purchase commodity data during the customer's moving in the store, it is sufficient that each commodity to be purchased is delivered to the customer at the end. It is not always necessary that each commodity to be purchased is stacked up in the usual shopping cart. In short, each commodity data to be purchased is input, and the actual commodity may be delivered to the customer in case of settlement of the account. In this case, the basket to stack up the purchase commodity in the usual shopping cart is not necessary. In short, component element necessary for the present invention is the information processing function of display processing, input processing, and communication processing. The shopping cart can be the shape of a PDA (Personal Data Assistant) type shown in FIG. 16 or shape of wearable type shown in FIG. 17.

In the PDA type of FIG. 16, as component element of the shopping cart shown in FIG. 2, the display unit, the input unit, the location detection unit, the memory, the communication unit, the input control unit, the communication control unit, and the control unit are composed as one body. On the other hand, in the wearable type of FIG. 17, the display unit is spectacle type, and the input unit is wearable shape of the customer's fingers. The other component elements are put in a box case.

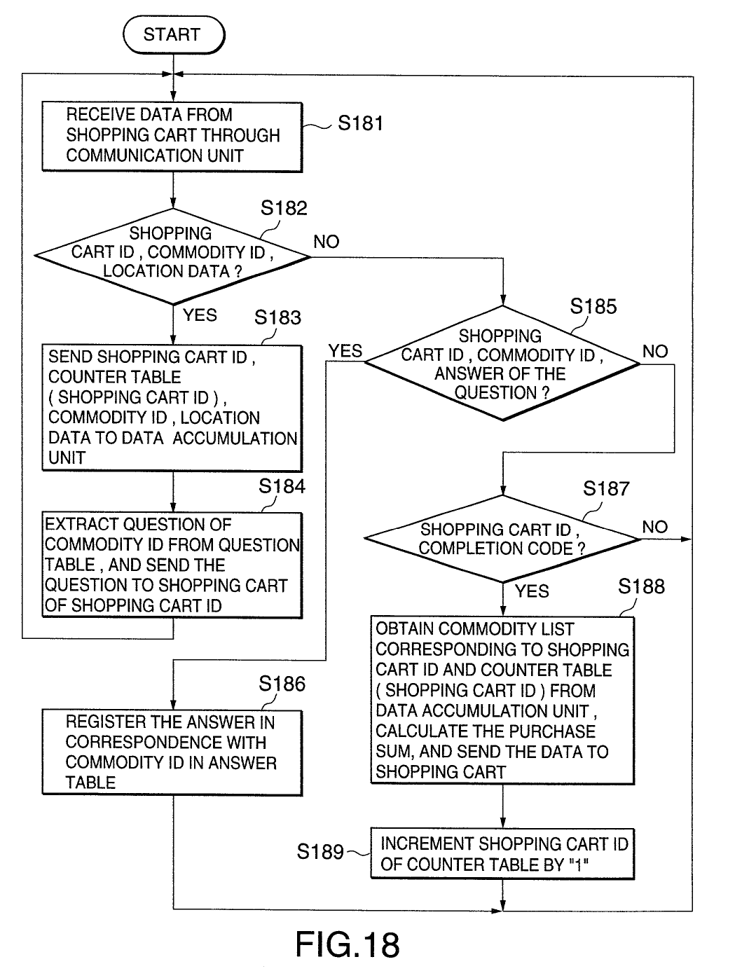

Next, in the third embodiment, when the customer purchases the commodity, the customer is urged to input data. For example, by inputting a reason to purchase the commodity, the customer's actual opinion for the purchase commodity can be collected. FIG. 18 is a flow chart of processing of the data collection server according to the third embodiment. A specific point different from the first embodiment (FIG. 4) is that, when the customer purchases a commodity, a question related to the commodity is extracted from a question table and the question is sent to the shopping cart. Furthermore, if an answer of the customer for the question is received from the shopping cart, the answer is registered in an answer table.

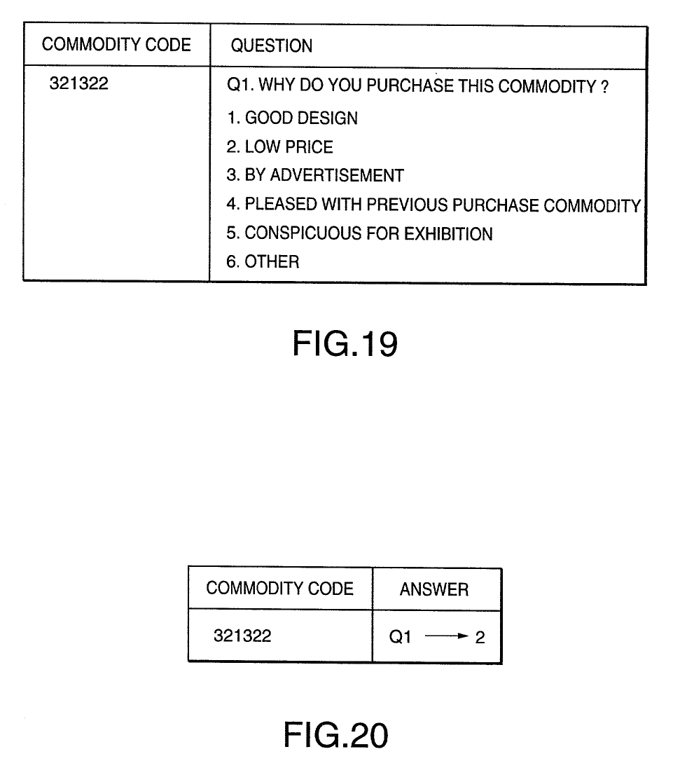

FIG. 19 is one example of the question table. As shown in FIG. 19, an ID code of commodity and a question are correspondingly stored in the memory of the data collection server. FIG. 20 is one example of the answer table. As shown in FIG. 20, the ID code of commodity and the answer are correspondingly stored in the memory of data collection service. In this example, as for the question Q1 “Why do you purchase this commodity?” related to the commodity ID code “321322”, the answer 2 “low price” stored in the question table is inputted by the customer.

As shown in processing of FIG. 18, when the data is received from the shopping cart (S181), it is decided whether the data is purchase commodity data (the shopping cart ID, the commodity ID, the location data), answer data (the shopping cart ID, the commodity ID, the answer) for the question, or completion data (the shopping cart ID, the completion code)(S182). Based on the decision result, corresponding processing is executed. In case of the purchase commodity data (the shopping cart ID, the commodity ID, the location data), these data are sent to the data accumulation unit 20 (S183). By referring to the question table, a question related to the purchase commodity is sent to the shopping cart (S184). In case of the answer data (the shopping cart ID, the commodity ID, the answer)(Sl85), content of the answer is registered in the answer table (S186). In case of the completion data (the shopping cart ID, the completion code)(S187), a completion processing such as calculation of the sum of the purchase commodities is executed. A list and the sum of the purchase commodities are sent to the shopping cart (S188). Then, the shopping cart ID in the counter table is incremented by “1” (S189.)

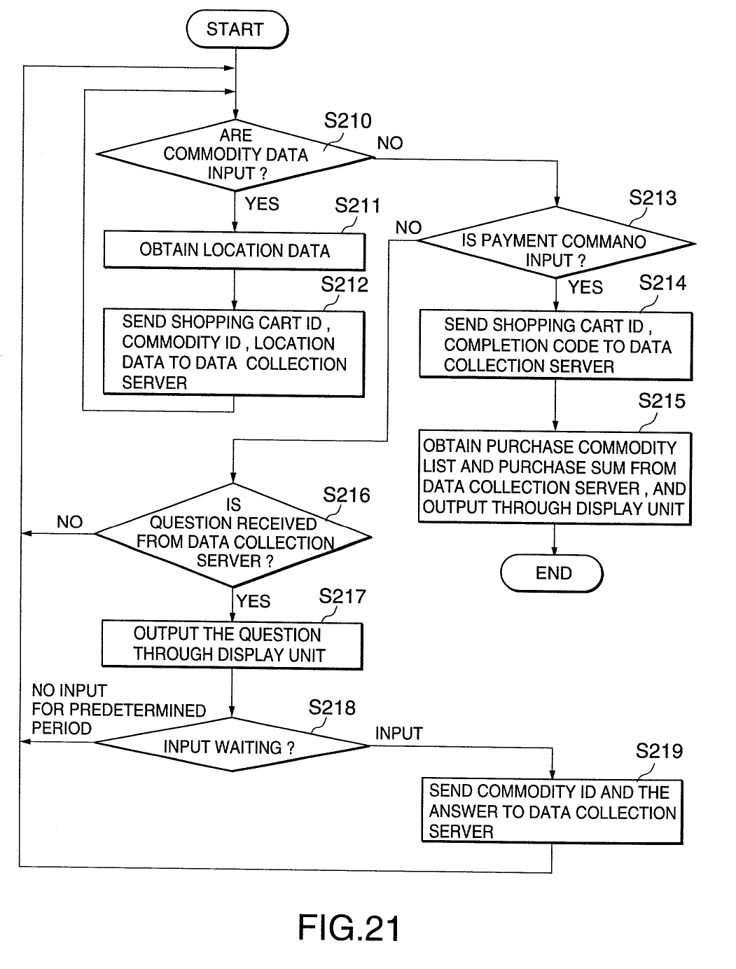

FIG. 21 is a flow chart of processing of the shopping cart. A specific point different from the first embodiment is that, a question related to the commodity sent from the data collection server is displayed in order for a customer to urge to input an answer, and the answer inputted by the customer is sent to the data collection server. First, when the shopping cart is activated, the control unit waits for the input data from the customer. If the input data from the customer is the commodity data (S210), the location detection unit detects the location data of the shopping cart (S211). Then, the communication unit 1 sends the ID code of the shopping cart, the ID code of the commodity, and the location data to the data collection server (S221). This processing is executed whenever the commodity data is inputted. On the other hand, when a payment command is inputted (S213), the ID code of the shopping cart and the completion code are sent to the data accumulation unit 20 of the data collection server by the communication units (S214). When the list of purchase commodities and the total amount of price of the purchase commodities are received from the data collection server, the display unit 4 displays the list and the total amount (S215). When a question is received from the data collection server (S216), the question is presented through the display unit (S217). If an answer for the question is inputted through the input unit (S218), the ID code of the commodity and the answer are sent to the data collection server (S219). As for the customer who answered to the question, discount service of purchase commodity may be executed in this system.

In order to realize the shopping cart of portable type shown in FIGS. 16 and 17 by a general portable information terminal, component shown in FIGS. 1,2, and 10 may be accomplished by computer-executable program, and this program can be realized as computer-readable memory device. In the present invention, the memory device, such as a magnetic disk, floppy disk, hard disk, optical disk (CD-ROM, CD-R, DVD, and so on), optical magnetic disk (MO, and so on) can be used to store instructions for causing a processor or computer to perform the processes described above.

Furthermore, based on indication of the program installed from the memory device to the computer, OS(operation system) operating on the computer, or MW(middle wear), such as database management software or network, may execute one part of each processing to realize the embodiments.

Furthermore, the memory device is not limited to a device independent from the computer. By downloading a program transmitted through LAN or Internet, a memory device in which the program is stored is included. Furthermore, the memory device is not limited to one. In case that the processing of the embodiments is executed by a plurality of memory devices, the plurality of memory devices is included in the memory device. The component of the device may be arbitrarily composed.

In the present invention, the computer executes each processing of the embodiments according to the program stored in the memory device. The computer may be one apparatus such as a personal computer or a system in which a plurality of apparatuses are connected through the network. Furthermore, in the present invention, the computer is not limited to the personal computer. The computer includes a processing unit in an information processor, a micro computer, and so on. In short, the equipment and the apparatus executable the function of the present invention using the program are generally called the computer.

As mentioned-above, in the present invention, the customer's tendency of purchase commodity is analyzed without the customer's burden. This analysis result is utilized as a presentation of advertisement and a planning of commodity exhibition. As a result, the commodity sale for the store greatly rises.

Other embodiments of the invention will be apparent to those skilled in the art from consideration of the specification and practice of the invention disclosed herein. It is intended that the specification and examples be considered as exemplary only, with the true scope and spirit of the invention being indicated by the following claims.

What is claimed is:

1. A commodity data management method, comprising:
inputting purchase commodity data of each customer in time series at the time the customer selects the commodity, and
determining a tendency of purchase commodity of each customer according to the purchase commodity data of each customer inputted in time series.

2. The commodity data management method according to claim 1,
at the inputting step, further comprising:
detecting a location of the customer associated with inputted purchase commodity data.

3. The commodity data management method according to claim 2,
further comprising:
correspondingly storing an identifier of the customer, an identification code of a purchase commodity, the location data of the customer, and an input time of the purchase commodity data in a purchase commodity table.

4. The commodity data management method according to claim 3,
at the determining step, further comprising:
selecting a pair of identification codes of purchase commodities of which a difference between two input times is below a threshold from the purchase commodity table, and
storing the pair of identification codes of purchase commodities in a data analysis result table.

5. The commodity data management method according to claim 4,
further comprising:
when the purchase commodity data of the customer is newly inputted at the inputting step,
deciding whether an identification code of the purchase commodity newly inputted matches one of the pair of identification codes of purchase commodities in the data analysis result table.

6. The commodity data management method according to claim 5,
further comprising:
if the identification code of the purchase commodity newly inputted matches one of the pair of identification codes of purchase commodities,
displaying an advertisement corresponding to the other of the pair of identification codes of purchase commodities to the customer.

7. The commodity data management method according to claim 6,
at the displaying step, further comprising:
displaying a location corresponding to the other of the pair of identification codes of purchase commodities to the customer according to a present location of the customer detected at the detecting step.

8. The commodity data management method according to claim 3,
further comprising:
when the purchase commodity data is inputted at the inputting step;
displaying a question related to the purchase commodity to the customer, and
inputting an answer of the customer for the question.

9. The commodity data management method according to claim 3,
further comprising:
when a payment command is inputted at the inputting step,
displaying a list and a total price of purchased commodities inputted until then to the customer.

10. A commodity data input and output apparatus, comprising:
an input unit configured to input purchase commodity data of each customer in time series at the time the customer selects the commodity; and
a communication unit configured to send the purchase commodity data of each customer to a commodity data management apparatus.

11. The commodity data input and output apparatus according to claim 10,
further comprising:
a location detection unit configured to detect a location of the customer associated with inputted purchase commodity data.

12. The commodity data input and output apparatus according to claim 11,
wherein said communication unit sends an identification code of said commodity data input and output apparatus, and the location data of the customer with the purchase commodity data to said commodity data management apparatus.

13. The commodity data input and output apparatus according to claim 12,
wherein said communication unit receives commodity presentation data usable for the customer's next purchase from said commodity data management apparatus.

14. The commodity data input and output apparatus according to claim 13,
further comprising:
a display unit configured to display the commodity presentation data to the customer.

15. The commodity data input and output apparatus according to claim 14,
when said input unit inputs a payment command from the customer,
wherein said communication unit sends the identification code of said commodity data input and output apparatus, and a completion code to said commodity data management apparatus.

16. The commodity data input and output apparatus according to claim 15,
when said communication unit receives a list and a total price of purchased commodities from said commodity data management apparatus,
wherein said display unit displays the list and the total to the customer.

17. The commodity data input and output apparatus according to claim 16,
when said communication unit receives a question related to the purchase commodity from said commodity data management apparatus,
wherein said display unit displays the question to the customer.

18. The commodity data input and output apparatus according to claim 17,
when said input unit inputs an answer to the question from the customer,
wherein said communication unit sends the answer and an identification code of the purchase commodity to said commodity data management apparatus.

19. A method for inputting and outputting commodity data, comprising:
inputting purchase commodity data of each customer in time series at the time the customer selects the commodity; and
sending the purchase commodity data of each customer to a commodity data management apparatus.

20. A computer program product for use with a computer, comprising:
a computer usable medium having computer readable program code embodied in said medium for causing said computer to input and output commodity data, said computer readable program code having:
computer readable program code to input purchase commodity data of each customer in time series at the time the customer selects the commodity; and
computer readable program code to send the purchase commodity data of each customer to a commodity data management apparatus.

21. A commodity data management apparatus, comprising:
a communication unit configured to receive purchase commodity data of each customer in time series at the time the customer selects the commodity from a commodity data input and output apparatus; and
a data analysis unit configured to determine a tendency of purchase commodity of each customer according to the purchase commodity data of each customer received.

22. the commodity data management apparatus according to claim 21,
wherein said communication unit receives an identification code of the commodity data input and output apparatus, an identification code of a commodity, and location data of the customer purchasing the commodity.

23. The commodity data management apparatus according to claim 22,
further comprising:
memory configured to correspondingly store the identification code of the commodity data input and output apparatus, the identification code of the commodity, the location data of the customer, and a receiving time in a purchase commodity table.

24. The commodity data management apparatus according to claim 23,
wherein said data analysis unit selects a pair of identification codes of purchase commodities of which an interval between two receiving times is below a predetermined period from the purchase commodity table, and
wherein said memory stores the pair of identification codes of purchase commodities in a data analysis result table.

25. The commodity data management apparatus according to claim 23,
when said communication unit receives the identification code of the commodity data input and output apparatus, and a completion code,
wherein said data analysis unit extracts a list of purchase commodities corresponding to the identification code of the commodity data input and output apparatus from the purchase commodity table, and calculates the total of the purchase commodities; and
wherein said communication unit sends the list of purchase commodities and the total of the purchase commodities to said commodity data input and output apparatus.

26. The commodity data management apparatus according to claim 24,
when said communication unit newly receives an identification code of purchase commodity,
wherein said data analysis unit decides whether the identification code of purchase commodity matches one of the pair of identification codes of purchase commodities in the purchase commodity table.

27. The commodity data management apparatus according to claim 26,
wherein said memory stores an advertisement corresponding to the identification code of each commodity.

28. The commodity data management apparatus according to claim 27,
if the identification code of purchase commodity matches one of the pair of identification codes of purchase commodities,
wherein said communication unit sends the advertisement corresponding to the other of the pair of identification codes and the commodity name to the commodity data input and output apparatus.

29. The commodity data management apparatus according to claim 26,
wherein said memory previously stores location data corresponding to the identification code of each commodity.

30. The commodity data management apparatus according to claim 29,
if the identification code of purchase commodity matches one of the pair of identification codes of purchase commodities,
wherein said communication unit sends the location data corresponding to the other of the pair of identification codes and the commodity name to the commodity data input and output apparatus.

31. The commodity data management apparatus according to claim 26,
wherein said memory previously stores a question corresponding to the identification code of each commodity, and
wherein said communication unit sends the question corresponding to the identification code of purchase commodity received to the commodity data input and output apparatus.

32. The commodity data management apparatus according to claim 31,
when said communication unit receives an answer for the question from the commodity data input and output apparatus,
wherein said memory correspondingly stores the answer and the identification code of the purchase commodity in an answer table.

33. A method for managing commodity data, comprising:
receiving purchase commodity data of each customer in time series at the time the customer selects the commodity from a commodity data input and output apparatus; and
determining a tendency of purchase commodity of each customer according to the purchase commodity data of each customer received.

34. A computer program product for use with a computer, comprising:
a computer usable medium having computer readable program code embodied in said medium for causing said computer to manage commodity data, said computer readable program code having:
computer readable program code to receive purchase commodity data of each customer in time series at the time the customer selects the commodity from a commodity data input and output apparatus, and
computer readable program code to determine a tendency of purchase commodity of each customer according to the purchase commodity data of each customer received.
